(19) United States
(12) Patent Application Publication
(10) Pub. No.: US 2025/0303305 A1
(43) Pub. Date: Oct. 2, 2025

(54) GENERATIVE MODEL FOR CANONICAL AND LOCALIZED GAME CONTENT

(71) Applicant: Electronic Arts Inc., Redwood City, CA (US)

(72) Inventors: Elisabeth Marie Murphy, Seattle, WA (US); John Michael Walton, Woodinville, WA (US)

(21) Appl. No.: 18/621,691

(22) Filed: Mar. 29, 2024

(51) Int. Cl. A63F 13/79; A63F 13/67

(52) U.S. Cl. CPC A63F 13/79; A63F 13/67

(57) ABSTRACT

The present disclosure provides a system for generating gameplay content by a generative modeling system. The system can generate gameplay content via one or more machine-learning models trained using game and player data. The system can add content generated by the one or more machine-learning models to the game and player data and retrain the models using the generated content. The system can also localize generated content based on player locations and language preferences.

### BACKGROUND

Personalizing gameplay may increase, enrich, and extend player engagement in videogames. Video games are often finite entities where a player may interact with every possible aspect of a storyline or a game world such that game elements may become repetitive over multiple game sessions leading to player disengagement. Additionally, making video games accessible to or tailored to people of different cultures or countries can require extensive development time as developers hard-code in variations in dialogue or imagery. The use of artificial intelligence in generating canonical and localized game content can enhance player experiences, leading to increased, enriched, and extended engagement, and result in more efficient development processes.

### SUMMARY OF EMBODIMENTS

The systems, methods, and devices of this disclosure each have several innovative aspects, no single one of which is solely responsible for all of the desirable attributes disclosed herein.

In some aspects, the techniques described herein relate to a computing system comprising: one or more processors; and one or more memory devices, wherein the one or more memory devices are communicatively coupled to the one or more processors, the one or more memory devices storing computer-executable instructions including at least a gameplay content generation system comprising base game data, global game data, a plurality of player accounts, and one or more gameplay generation models, wherein the base game data comprises one or more base game components, and wherein each of the plurality of player accounts is associated with a plurality of player data, wherein execution of the computer-executable instructions by the one or more processors causes, during runtime, at least one of the one or more processors to generate gameplay content within a virtual interactive environment of a video game by: receiving first player data, wherein the first player data is associated with a first player account of the plurality of player accounts; adding the first player data to a first plurality of player data associated with the first player account; training a first gameplay generation model of the one or more gameplay generation models using at least one of the global game data and the first plurality of player data; receiving a first request to generate gameplay content corresponding to a first base game component; generating first gameplay content, wherein the first gameplay content corresponds to the first base game component; adding the first gameplay content to the first plurality of player data and the global game data; and outputting the first gameplay content within the virtual interactive environment of the video game.

In some aspects, the techniques described herein relate to a computing system, wherein player data comprises at least one of: an amount of time a player has spent playing the video game, an amount of progress a player has made in completing a storyline of the video game, objects a player has previously interacted with in the video game, characters a player has previously interacted with in the video game, types of interactions the player has had within the video game, an percentage corresponding to how much of the virtual interactive environment the player has interacted with.

In some aspects, the techniques described herein relate to a computing system, wherein execution of the computer-executable instructions further causes at least one of the one or more processors to generate gameplay content by: retraining, by the gameplay content generation system, the first gameplay generation model using at least one of the global game data and first plurality of player data; receiving, at the gameplay content generation system, a second request to generate gameplay content corresponding to the first gameplay content; and generating, by the first gameplay generation model, second gameplay content, wherein the second gameplay content corresponds to the first gameplay content.

In some aspects, the techniques described herein relate to a computing system, wherein execution of the computer-executable instructions further causes at least one of the one or more processors to generate gameplay content by: transmitting, by the gameplay content generation system, the first gameplay content to an aggregator; and aggregating, by the aggregator, the first gameplay content, wherein aggregating the first gameplay content comprises: comparing the first gameplay content to third gameplay content, wherein the third gameplay content is gameplay content generated by a second gameplay generation model of the one or more gameplay generation models, and wherein the second gameplay generation model is trained, at least in part, on a second plurality of player data associated with a second player account of the plurality of player accounts, determining, based on comparing the first gameplay content to third gameplay content, to add the first gameplay content to the global game data, and adding the first gameplay content to the global game data.

In some aspects, the techniques described herein relate to a computing system, wherein at least one of the one or more gameplay generation models is a machine-learning model.

In some aspects, the techniques described herein relate to a computing system, wherein execution of the computer-executable instructions further causes at least one of the one or more processors to generate gameplay content by: transmitting the first gameplay content to a user platform, wherein the user platform is configured to communicate with one or more user computing devices.

In some aspects, the techniques described herein relate to a computing system, wherein execution of the computer-executable instructions further causes at least one of the one or more processors to generate gameplay content by: transmitting the first gameplay content to a localization system, wherein the localization system comprises one or more localization models; transmitting second player data associated with the first plurality of player data, the second player data comprising a preferred language associated with the first player account; and localizing, by the localization system, the first gameplay content, wherein localizing the first gameplay content comprises: inputting into at least one of the one or more localization models the first gameplay content and the second player data, wherein the first gameplay content is associated with a language different from the preferred language, and receiving from the at least one of the one or more localization models, third gameplay content wherein the third gameplay content is associated with the preferred language.

In some aspects, the techniques described herein relate to a computing system, wherein the localization system further comprises a filter, and wherein execution of the computer-executable instructions further causes at least one of the one or more processors to generate gameplay content by: filtering, by the filter, the third gameplay content, wherein filtering the third gameplay content comprises: determining that the third gameplay content contains at least one of profanities or banned content, inputting the third gameplay content into a machine-learning model, and receiving fourth gameplay content, wherein the fourth gameplay content does not contain profanities or banned content.

In some aspects, the techniques described herein relate to a computing system, wherein execution of the computer-executable instructions further causes at least one of the one or more processors to generate gameplay content by: receiving, at the gameplay content generation system, second player data, wherein the second player data is associated with a second player account of the plurality of player accounts; adding the second player data to a second plurality of player data associated with the second player account; training, by the gameplay content generation system, a second gameplay generation model of the one or more gameplay generation models using at least one of the global game data and the second plurality of player data; receiving, at the gameplay content generation system, a third request to generate gameplay content corresponding to the first base game component; and generating, by the first gameplay generation model, third gameplay content, wherein the third gameplay content corresponds to the first base game component, and wherein the third gameplay content is different from the first gameplay content.

In some aspects, the techniques described herein relate to a computer-implemented method to generate gameplay content within a virtual interactive environment of a video game comprising: receiving, at a gameplay content generation system, first player data, wherein the gameplay content generation system comprises: base game data, global game data, a plurality of player accounts, and one or more gameplay generation models, wherein the base game data comprises one or more base game components, and wherein each of the plurality of player accounts is associated with a plurality of player data, and wherein the first player data is associated with a first player account of the plurality of player accounts; adding the first player data to a first plurality of player data associated with the first player account; training a first gameplay generation model of the one or more gameplay generation models using at least one of the global game data and the first plurality of player data; receiving a first request to generate gameplay content corresponding to a first base game component; generating first gameplay content, wherein the first gameplay content corresponds to the first base game component; adding the first gameplay content to the first plurality of player data and the global game data; and outputting the first gameplay content within the virtual interactive environment of the video game.

In some aspects, the techniques described herein relate to a computer-implemented method, wherein player data comprises at least one of: an amount of time a player has spent playing the video game, an amount of progress a player has made in completing a storyline of the video game, objects a player has previously interacted with in the video game, characters a player has previously interacted with in the video game, types of interactions the player has had within the video game, an percentage corresponding to how much of the virtual interactive environment the player has interacted with.

In some aspects, the techniques described herein relate to a computer-implemented method, further comprising: retraining, by the gameplay content generation system, the first gameplay generation model using at least one of the global game data and first plurality of player data; receiving, at the gameplay content generation system, a second request to generate gameplay content corresponding to the first gameplay content; and generating, by the first gameplay generation model, second gameplay content, wherein the second gameplay content corresponds to the first gameplay content.

In some aspects, the techniques described herein relate to a computer-implemented method, further comprising: transmitting, by the gameplay content generation system, the first gameplay content to an aggregator; and aggregating, by the aggregator, the first gameplay content, wherein aggregating the first gameplay content comprises: comparing the first gameplay content to third gameplay content, wherein the third gameplay content is gameplay content generated by a second gameplay generation model of the one or more gameplay generation models, and wherein the second gameplay generation model is trained, at least in part, on a second plurality of player data associated with a second player account of the plurality of player accounts, determining, based on comparing the first gameplay content to third gameplay content, to add the first gameplay content to the global game data, and adding the first gameplay content to the global game data.

In some aspects, the techniques described herein relate to a computer-implemented method, wherein at least one of the one or more gameplay generation models is a machine-learning model.

In some aspects, the techniques described herein relate to a computer-implemented method, further comprising: transmitting the first gameplay content to a user platform, wherein the user platform is configured to communicate with one or more user computing devices.

In some aspects, the techniques described herein relate to a computer-implemented method, further comprising: transmitting the first gameplay content to a localization system, wherein the localization system comprises one or more localization models; transmitting second player data associated with the first plurality of player data, the second player data comprising a preferred language associated with the first player account; and localizing, by the localization system, the first gameplay content, wherein localizing the first gameplay content comprises: inputting into at least one of the one or more localization models the first gameplay content and the second player data, wherein the first gameplay content is associated with a language different from the preferred language, and receiving from the at least one of the one or more localization models, third gameplay content wherein the third gameplay content is associated with the preferred language.

In some aspects, the techniques described herein relate to a computer-implemented method, wherein the localization system further comprises a filter, and wherein the computer-implemented method further comprises: filtering, by the filter, the third gameplay content, wherein filtering the third gameplay content comprises: determining that the third gameplay content contains at least one of profanities or banned content, inputting the third gameplay content into a machine-learning model, and receiving fourth gameplay content, wherein the fourth gameplay content does not contain profanities or banned content.

In some aspects, the techniques described herein relate to a computer-implemented method, further comprising: receiving, at the gameplay content generation system, second player data, wherein the second player data is associated with a second player account of the plurality of player accounts; adding the second player data to a second plurality of player data associated with the second player account; training, by the gameplay content generation system, a second gameplay generation model of the one or more gameplay generation models using at least one of the global game data and the second plurality of player data; receiving, at the gameplay content generation system, a third request to generate gameplay content corresponding to the first base game component; and generating, by the first gameplay generation model, third gameplay content, wherein the third gameplay content corresponds to the first base game component, and wherein the third gameplay content is different from the first gameplay content.

In some aspects, the techniques described herein relate to a non-transitory computer readable medium comprising computer-executable instructions that, when executed by one or more processors, cause the one or more processors to generate gameplay content within a virtual interactive environment of a video game by: receiving, at a gameplay content generation system, first player data, wherein the gameplay content generation system comprises: base game data, global game data, a plurality of player accounts, and one or more gameplay generation models, wherein the base game data comprises one or more base game components, and wherein each of the plurality of player accounts is associated with a plurality of player data, and wherein the first player data is associated with a first player account of the plurality of player accounts; adding the first player data to a first plurality of player data associated with the first player account; training a first gameplay generation model of the one or more gameplay generation models using at least one of the global game data and the first plurality of player data; receiving a first request to generate gameplay content corresponding to a first base game component; generating first gameplay content, wherein the first gameplay content corresponds to the first base game component; adding the first gameplay content to the first plurality of player data and the global game data; and outputting the first gameplay content within the virtual interactive environment of the video game.

In some aspects, the techniques described herein relate to a non-transitory computer readable medium, wherein execution of the computer-executable instructions further causes the one or more processors to generate gameplay content by: transmitting, by the gameplay content generation system, the first gameplay content to an aggregator, and aggregating, by the aggregator, the first gameplay content, wherein aggregating the first gameplay content comprises: comparing the first gameplay content to third gameplay content, wherein the third gameplay content is gameplay content generated by a second gameplay generation model of the one or more gameplay generation models, and wherein the second gameplay generation model is trained, at least in part, on a second plurality of player data associated with a second player account of the plurality of player accounts, determining, based on comparing the first gameplay content to third gameplay content, to add the first gameplay content to the global game data, and adding the first gameplay content to the global game data.

Although certain embodiments and examples are disclosed herein, inventive subject matter extends beyond the examples in the specifically disclosed embodiments to other alternative embodiments and/or uses, and to modifications and equivalents thereof.

### BRIEF DESCRIPTION OF THE DRAWINGS

Throughout the drawings, reference numbers are re-used to indicate correspondence between referenced elements. The drawings are provided to illustrate embodiments of the subject matter described herein and not to limit the scope thereof.

FIG. 1 illustrates a hardware environment, according to an example embodiment.

FIG. 2 illustrates a software environment, according to an example embodiment.

FIG. 3 illustrates an example embodiment of a generative modeling system for generating canonical and localized game content.

FIG. 4A illustrates a data flow diagram of example communications between various computing devices and systems described herein to generate canonical and localized game content for a video game.

FIG. 4B illustrates a flowchart of an example process for generating gameplay content.

FIG. 5 illustrates a schematic diagram of base game components, a first tree of generated gameplay content, a second tree of generated gameplay content, and a generated game component, according to an embodiment.

FIGS. 6A-6C illustrate schematic diagrams of a first depiction of a generated gameplay content expressed in a virtual space and a second depiction of a generated gameplay content expressed in a virtual space as perceived by different entities, according to several embodiments.

FIG. 7 illustrates an example embodiment of a computing device.

### DETAILED DESCRIPTION

### Overview

The systems and methods described herein provide for a generative modeling system for canonical and localized game content, such as for video games.

Evolving gameplay and player personalization may increase and extend player engagement in a game. When a player knows they will encounter new game content during each game session, they may be more likely to reengage with the game. Additionally, players may be more likely to engage in a game tailored to their culture, one that does not merely use literal translation for content but generates content unique to the player's culture.

Accordingly, a system may be designed that can utilize machine-learning models to generate personalized canonical gameplay content, use the generated gameplay content to further train the machine-learning models, and localize the generated gameplay content to individual players. For example, during gameplay, the system can generate, via one or more machine-learning models, gameplay based on game data, such as game lore, mechanics, or character narratives, and based on player data, such as the age or skill level of a player. The system can further train the machine-learning models using the generated data to evolve the game and player data, enabling different content generation during or across game sessions.

Additionally, the system can feed the generated content to a localization system that utilizes one or more machine-learning models to localize the generated content for a player. For instance, generated content may comprise audio or dialogue for a sportscaster. The system can localize the dialogue depending on where a player is from to better represent the local sports casters. For instance, British sportscasters may have a different cadence or rhythm when commenting on a soccer game as compared to Mexican sportscasters commenting on the same game. The system can train on or more machine-learning models to generate content appropriate for a player's culture. Additionally, the system can use one or more machine-learning models to ensure that generated content complies with cultural rules or norms. For instance, certain words or phrases may be mundane in one language, and profane in another. The system can analyze and detect such profanity in generated content and generate culturally appropriate replacement content for display to a user.

### Computing Environment

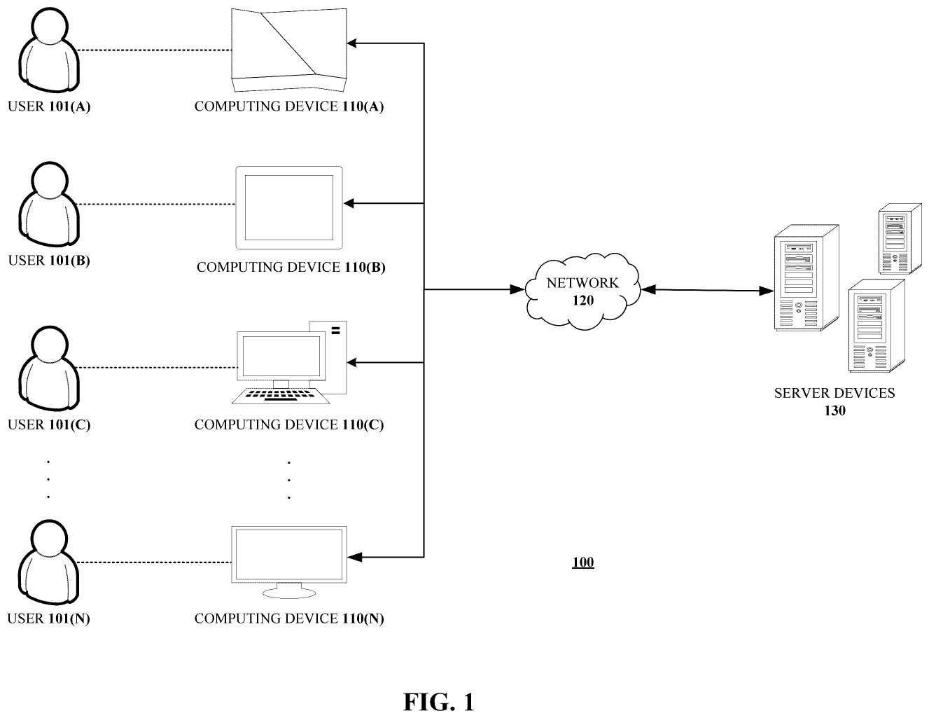

FIG. 1 illustrates an example embodiment of computing environment 100 to design, develop, test, and/or play a video game—or one or more aspects, features, and/or services thereof—among other things. Computing environment 100 includes communicatively coupled hardware devices. In some embodiments, one or more hardware devices among computing environment 100 include computer executable instructions configured to train and/or use machine-learning models to generate canonical and/or localized gameplay content.

As shown, computing environment 100 including users 105(A), 105(B), 105(C), and 105(N) (collectively referred to herein as “105” or “users 105”) and computing devices 110(A), 110(B), 110(C), and 110(D) (collectively referred to herein as “110 or “computing devices 110”) that are communicatively coupled to server devices 130 over network 120. In some embodiments, “N” of user 105(N) and computing devices 110(N) is an arbitrary real value that denotes an “A through N” number of users 105 and/or computing devices 110 among computing environment 100.

Users 105 can be players, developers, designers and/or automated agents (hereinafter “agent” in short), among other types. In some embodiments, there is a one-to-one correspondence between the users 105 and the computing devices 110. In some embodiments, there is an N-to-one or one-to-N (wherein “N” is an arbitrary real value) correspondence between the users 105 and the computing devices 110. It should be understood that as described in the present disclosure, a “user” on or of a computing device is synonymous with a “player”, “developer”, “designer” or an “agent”. An agent, as known to a person of ordinary skill in the art, can be configured by way of a machine learning model and/or software to automate one or more tasks; such as, for example, playing or testing a video game.

Computing devices 110 are exemplary hardware devices including computer executable instructions configured for designing, developing, maintaining, monitoring, analyzing, testing, updating, streaming, and/or playing a video game—or one or more aspects, features, and/or services thereof—among other things. As illustrated by way of example in the embodiment of FIG. 1, computing device 110(A) is a video game console; computing device 110(B) is a mobile device; computing device 110(C) is a personal computer; and computing device 110(D) is a display device. In some embodiments, two or more of the computing devices 110 are similar to one another—e.g., of a same type.

In some embodiments, user 105 provides input to computing devices 110 by way of one or more input devices and/or input methods corresponding and/or associated to computing devices 110, as known to a person of ordinary skill in the art. In some embodiments, computing devices 110 can provide output to users 105 by way of one or more output devices and/or output methods corresponding and/or associated to computing devices 110, as known to a person of ordinary skill in the art.

Network 120 communicatively couples computing devices 110 and server devices 130, among other hardware devices. In some embodiments, network 120 includes any method of private and/or public connectivity, networking, and/or communication between or among hardware devices known in the arts. As non-limiting examples, network 120 may include direct wired connections, Near Field Communication (NFC), a Local Area Network (LAN), a Virtual Private Network (VPN), an internet connection, or other communication methods of the like.

Server devices 130 are exemplary hardware devices including computer executable instructions configured to provide services (i.e., remote or cloud services) corresponding to designing, developing, maintaining, monitoring, analyzing, testing, updating, streaming, and/or playing of a video game—or one or more aspects and/or features thereof—among other things to computing devices 110 over network 120. The one or more hardware devices of server devices 130 can be communicatively coupled to one or more computing devices 110 over network 120, among other hardware devices and/or other networking methods.

The exemplary hardware devices of computing devices 110 and server devices 130 include at least one or more processors, graphic processors, memory, and storage, in addition to networking capabilities. In some embodiments, computing devices 110 include computer executable instructions configured to perform one or more functions, tasks, or services of and/or for server devices 130. In some embodiments, server devices 130 include computer executable instructions configured to perform one or more functions, tasks, or services of and/or for computing devices 110.

In some embodiments, computing devices 110 and server devices 130 include computer executable instructions configured to provide and/or enable remote access among hardware devices, such as over network 120. For example, computing device 110(A) may remote access computing device 110(C) and/or one or more hardware devices of server devices 130. In some embodiments, computing devices 110 include computer executable instructions configured to request and/or provide data to server devices 130, such as over network 120. In some embodiments, server devices 130 include computer executable instructions configured to request and/or provide data to computing devices 110, such as over network 120.

In some embodiments, there is an association of a user 105 to one or more user accounts of, or corresponding to, computing devices 110 and/or server devices 130. In some embodiments, there is an association of a user 105 to one or more user accounts corresponding to software and/or video games included, stored, and/or executed among computing devices 110 and/or server devices 130. In some embodiments, user accounts in association with a user 105 are validated by computing devices 110 and/or server devices 130 by one or more methods known to a person of ordinary skill in the art. In some embodiments, agents—as users 105—are deployed, controlled, and/or directed by computing devices 110 and/or server devices 130 by one or more methods known to a person of ordinary skill in the art to perform and/or automate one or more tasks among computing devices 110 and/or server devices 130, among other things.

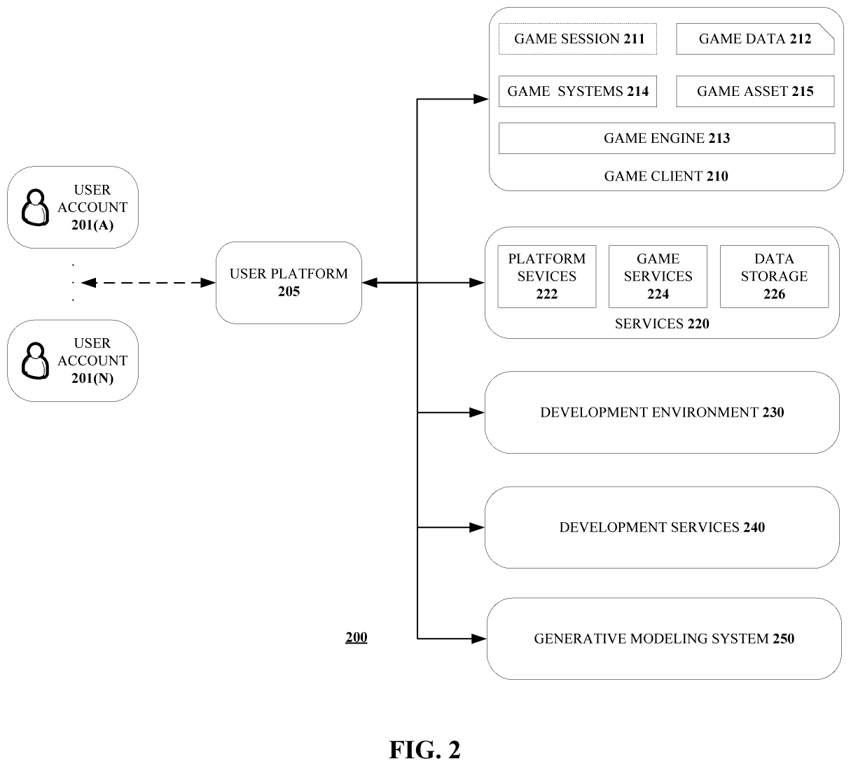

FIG. 2 illustrates an example embodiment of a software environment 200 to design, develop, test, and/or play a video game—or one or more aspects, features, and/or services thereof—among other things. Software environment 200 includes a number of software (i.e., computer executable instructions) distributed over—and/or executable on—one or more communicatively coupled hardware devices, similar to computing device 110 and server device 130 over network 120 of FIG. 1. In some embodiments, the software among software environment 200 is used to train and/or use machine-learning models to generate canonical and/or localized gameplay content.

Software environment 200 includes user platform 205, game client 210, service 220, development environment 230, and development service 240. In some embodiments, the software among software environment 200 is configured with computer executable instructions to communicate data.

User platform 205 includes computer executable instructions configured to access and/or manage software and/or services associated with user platform 205, among other things; such as, for example, game clients 210, services 220, development environment 230, and/or development services 240.

In some embodiments, user platform 205 supports and/or requires a “users account” for accessing and/or managing software and/or services associated with user platform 205. As illustrated by way of example in the embodiment of FIG. 2, user account 201(A) through user account 201(N) are accounts of users (similar to users 105 of FIG. 1) that correspond to user platform 205; wherein “N” is arbitrary real value used to denote an “A through N” amount of user accounts (herein collectively referred to as “201”). In some embodiments, each user account 201 may locally execute and/or remotely access or communicate with one or more of the software and/or services among software environment 200 from or on one or more hardware devices.

In some embodiments, user accounts 201 include data provided by users, such as a username, which identifies a user account 201 (and in turn a user) among software environment 200. In some embodiments, data corresponding to and/or communicated among software environment 200 can be associated to and/or with user platform 205 and one or more user accounts 201. In some embodiments, data corresponding to user platform 205—and one or more user accounts 201—is associated to or with game clients 210, services 220, development environment 230, and/or development service 240, among other things.

In some embodiments, User Platform 205 is also configured to execute one or more of the software among software environment 200. For example, user platform 205 may be a computing device configured to access and execute video games or configured to access and execute software corresponding to a video game, such as a companion application.

Game client 210 is software including, comprising, and/or composing of a video game, or portion thereof. Game client 210 includes game client components (213, 214, and 215) and game data 212 that can be utilized to produce and/or maintain game session 211; or multiples thereof.

Game session 211 is an instance of one or more virtual interactive environments of game client 210. In some embodiments, a virtual interactive environment includes one or more virtual levels and/or graphical user interfaces providing an interactive virtual area or virtual space for gameplay and/or socializing. For example, game session 211 can be among a game level or social space, which may include one or more player characters, non-player characters, quests, objectives, and other features, elements, or aspects known in the art. The virtual interactive environment may have a topography and include one or more objects positioned within the topography that are capable of locomotion within the topography. In some instances, the topography may include a two-dimensional topography. In other instances, the topography may include a three-dimensional topography. In some embodiments, game session 211 is produced and/or maintained in part by game data 212, game engine 213, game systems 214, and game assets 215, among other things; such as, for example, user platform 205 and/or services 220.

As a non-limiting example, a first instance of a game session may be of a first version of a first virtual interactive environment, while a subsequent instance of a game session may be of a subsequent version of the first virtual interactive environment, such that there are one or more changes or differences among the first virtual interactive environment between the two instances of the game session.

Game session 211 may include a number of player characters and/or non-player characters. Player characters of game session 211 can refer to controllable character models configured to facilitate or perform gameplay actions or commands. In some embodiments, a user or player can control and/or direct one or more player characters in a virtual interactive environment of game session 211. The term “non-player character” corresponds to character models that are not controlled and/or directed by players (commonly known as “NPCs”). An NPC can be configured with computer executable instructions to perform one or more tasks and/or actions among the gameplay of game session 211 (i.e., gameplay actions); such as with and/or without interaction with or from a player character.

The game session 211 may include a number of player objects. Player objects of game session 211 can refer to controllable objects, or models, used to facilitate or enable gameplay or other in-game actions. Player objects may be, for example, vehicles, vessels, aircraft, ships, tiles, cards, dice, pawns, and other in-game items of the like known to those of skill in the art. In some embodiments, a user or player can control or direct one or more player objects in game session 211, including, in some instances, by controlling player characters which in turn causes the objects to be controlled.

For simplicity, player characters and player objects are collectively referred to herein as player characters in some embodiments. It should be understood that, as used herein, “controllable” refers to the characteristic of being able and/or configured to be controlled and/or directed (e.g., moved, modified, etc.) by a player or user through one or more input means, such as a controller or other input device, by a player or user. As known to a person of ordinary skill in the art, player characters include character models configured to receive input.

Game data 212 is data corresponding to one or more aspects of game client 210, such as gameplay. In some embodiments, game data 212 includes data such as state data, simulation data, rendering data, and other data types of the like.

State data is commonly known as data describing a state of a player character, virtual interactive environment, and/or other virtual objects, actors, or entities—in whole or in part—at one or more instances or periods of time during a game session of a video game. For example, state data can include the current location and condition of one or more player characters among a virtual interactive environment at a given time, frame, or duration of time or number of frames.

Simulation data is commonly known as the underlying data corresponding to simulation (i.e., physics and other corresponding mechanics) to drive the simulation of a model or object in a game engine. For example, simulation data can include the joint and structural configuration of a character model and corresponding physical forces or characteristics applied to it at instance or period of time during gameplay, such as a “frame”, to create animations, among other things.

Render Data is commonly known as the underlying data corresponding to rendering (e.g., visual, and auditory rendering) aspects of a game session, which are rendered (e.g., for output to an output device) by a game engine. For example, render data can include data corresponding to the rendering of graphical, visual, auditory, and/or haptic output of a video game, among other things. During rendering, the luminance can be computed. The rendering process can be performed by various hardware and software components. For example, luminance can be computed on a CPU (single or multiple threads), using graphics hardware via interfaces such as OpenGL or DirectX, or using the GPGU approach like CUDA or JAX. In some embodiments, cloud computing can be utilized for parallelization.

In some embodiments, game session 211 is based in part on game data 212. During game session 211 (e.g., runtime execution), one or more aspects of gameplay (e.g. rendering, simulation, state, gameplay actions of player characters) uses, produces, generates, and/or modifies game data 212 or portion thereof. Likewise, gameplay events, objectives, triggers, and other aspects, objects, or elements of the like also use, produce, generate, and/or modify game data 212, or a portion thereof. In some embodiments, game data 212 includes data produced or generated over the course of a number of game sessions associated with one or more game clients 210. Game data 212 may be updated, versioned, and/or stored periodically as a number of files to a memory device associated with game client 210, or remotely on a memory device associated with a game server or game service, such as data storage 226. Additionally, game data 212, or copies and/or portions thereof, can be stored, referenced, categorized, or placed into a number of buffers or storage buffers. A buffer can be configured to capture particular data, or data types, of game data 212 for processing and/or storage. These buffers can be used by game client 210, service 220, user platform 205, development environment 230, and/or development services 240 for performing one or more tasks.

Game client components (e.g., game engine 213, game systems 214, and game assets 215) are portions or subparts of game client 210 that provide the underlying frameworks and software that support and facilitate features corresponding to gameplay, such as instancing game sessions that connect one or more user accounts for gameplay among a virtual interactive environment.

Game engine 213 is a software framework configured with computer executable instructions to execute computer executable instructions corresponding to a video game (e.g., game code). In some embodiments, game engine 213 is a distributable computer executable runtime portion of development environment 230. In some embodiments, game engine 213 and development environment 230 are game code agnostic.

In some embodiments, game engine 213 includes, among other things, a renderer, simulator, and stream layer. In some embodiments, game engine 213 uses game data (e.g., state data, render data, simulation data, audio data, and other data types of the like) to generate and/or render one or more outputs (e.g., visual output, audio output, and haptic output) for one or more hardware devices.

As used herein in some embodiments, a renderer is a graphics framework that manages the production of graphics corresponding to lighting, shadows, textures, user interfaces, and other effects or game assets of the like. As used herein in some embodiments, a simulator refers to a framework that manages simulation aspects corresponding to physics and other corresponding mechanics used in part for animations and/or interactions of gameplay objects, entities, characters, lighting, gasses, and other game assets or effects of the like.

As used herein in some embodiments, a stream layer is a software layer that allows a renderer and simulator to execute independently of one another by providing a common execution stream for renderings and simulations to be produced and/or synchronized (i.e., scheduled) at and/or during runtime. For example, a renderer and simulator of game engine 213 may execute at different rates (e.g., ticks, clocks) and have their respective outputs synchronized accordingly by a stream layer.

As used herein in some embodiments, game engine 213 also includes an audio engine or audio renderer that produces and synchronizes audio playback with or among the common execution of a stream layer. In some embodiments, an audio engine of game engine 213 can use game data to produce audio output and/or haptic output from game data. In some embodiments, an audio engine of game engine 213 can transcribe audio data or text data to produce audio haptic output.

Game systems 214 includes software configured with computer executable instructions that provide, facilitate, and manage gameplay features and gameplay aspects of game client 210. In some embodiments, game systems 214 includes the underlying framework and logic corresponding to gameplay of game client 210. For simplicity, game systems 214 are the “game code” that compose a video game of game client 210. As such, game systems 214 are used in part to produce, generate, and maintain gameplay among an instance of a virtual interactive environment, such as the gameplay among game session 211.

As used herein in some embodiments, game engine 213 and/or game systems 214 can also use and/or include Software Development Kits (SDKs), Application Program Interfaces (APIs), Dynamically Linked Libraries (DLLs), and other software libraries, components, modules, shims, or plugins that provide and/or enable a variety of functionality to game client 210; such as—but not limited to—graphics, audio, font, or communication support, establishing and maintaining service connections, performing authorizations, and providing anti-cheat and anti-fraud monitoring and detection, among other things.

Game assets 215 are digital assets that correspond to game client 210. In some embodiments, the game assets 215 can include virtual objects, character models, actors, entities, geometric meshes, textures, terrain maps, animation files, audio files, digital media files, font libraries, visual effects, and other digital assets commonly used in video games of the like. As such, game assets 215 are the data files used in part to produce the runtime of game client 210, such as the virtual interactive environments and menus. In some embodiments, game engine 213 and/or game systems 214 reference game assets 215 to produce game session 211.

In some embodiments, game client 210 can be played and/or executed on one or more hardware devices, such as computing devices 110 and server devices 130 of FIG. 1. In some embodiments, there are a number of game clients 210 that may include variations among one another: such as including different software instructions, components, graphical configurations, and/or data for supporting runtime execution among different hardware devices.

For example, multiple game clients 210 can be of the same video game wherein one game client 210 includes variations for support on a video game console (such as computing device 110(A) in FIG. 1), while another game client 210 includes variations for support on a mobile device (such as computing device 110(B) in FIG. 1). However, since the game clients are of the same video game, both game clients can connect to the same instance of a game session (such as game session 211) to enable user accounts 201 of user platform 205 to interact with one another by being communicatively coupled; such as by hardware devices running and/or accessing a game client 210 in communication with services 220.

Service 220 are software services including computer executable instructions configured to provide a number of services to user platform 205 and/or game client 210. As illustrated by way of example in FIG. 2, services 220 includes, but is not limited to, platform services 222, gameplay services 224, and data storage 226. In some embodiments, services 220 includes computer executable instructions configured and/or provided by development environment 230 and/or development services 240.

Platform services 222 includes computer executable instructions configured to provide anti-fraud detection, software management, user account validation, issue reporting, and other services corresponding to user platform 205 of the like.

Gameplay services 224 includes computer executable instructions configured to provide matchmaking services, game state management, anti-fraud detection, economy management, player account validation, and other services corresponding to gameplay of the like to game clients 210.

In some embodiments, platform services 222 and/or gameplay services 224 establish and maintain connections that, at least in part, facilitate gameplay in a game session of game client 210, such that game session 211 of game client 210 connects one or more users accounts 201 of user platform 205 for multiplayer gameplay and/or multi-user interaction among an instance of a virtual interactive environment.

Data storage 226 provides data storage management services to the software among software environment 200. In some embodiments, data communicated by and/or corresponding to elements 205, 201, 210, 220, 230, 240 and 250 may be stored, versioned, and/or managed—as one or more files—to and/or by data storage 226 or one or more hardware devices corresponding to software environment 200.

In some embodiments, Game clients 210 and user platform 205 can communicate with service 220 over a network, such as network 120 illustrated in FIG. 1. In some embodiments, service 220 is provided by server devices 130 of FIG. 1. In some embodiments, game client 210 and/or user platform 205 can require a user account 201 to access one or more features of game client 210; such as social gaming features including multiplayer game sessions or player to player communications. Respectively, data, such as game data 212 corresponding to one or more game sessions of game client 210 can be associated to user accounts 201 in some embodiments.

Development Environment 230 is software enabling the development or maintenance of one or more aspects, features, tools, and/or services corresponding to one or more of the software among software environment 200. In some embodiments, development environment 230 is a collection of tools, frameworks, services, and other computer executable instructions and applications of the like, such as, for example, a video game development engine. In some embodiments, development environment 230 can utilize external software—such as components, modules, libraries, plugins, and other systems of the like—to extend or expand functionality and/or capabilities.

Development Services 240 are software services including computer executable instructions configured to provide services corresponding to user platform 205, game client 210, services 220 and/or development environment 230. In some embodiments, development services 240 provide services similar to functionality and capabilities of development environment 230, thereby allowing and/or enabling development for software corresponding to, and/or aspects of, software environment 200. In some embodiments, development services 240 provide services to mock and/or simulate one or more components, services, or aspects of user platform 205, game client 210, and/or services 220, thereby allowing and/or enabling testing and/or validation, among other things, for one or more aspects corresponding to software environment 200.

The generative modeling system 250 is software including computer executable instructions configured to generate canonical and localized gameplay content in virtual interactive environments, such as for personalizing a video game. In some embodiments, generative modeling system 250 can utilize and/or leverage development environment 230, game client 210, and data storage 226 for configuration, training, and/or inference of one or more machine learning models for generating gameplay content.

As known to a person of ordinary skill in the art, gameplay content is content associated with a video game experience including, but not limited to, game lore, background imagery, character narratives, storytelling, character appearance, quests, interactive objects, non-interactive objects. Gameplay content may also comprise video game audio such as background music, character narration, environmental sounds, etc.

In some embodiments, software among or corresponding to software environment 200—and the corresponding systems and methods thereof—utilize machine learning. Machine learning is a subfield of artificial intelligence, which, to persons of ordinary skill of the art, corresponds to underlying algorithms and/or frameworks (commonly known as “neural networks” or “machine learning models”) that are configured and/or trained to perform and/or automate one or more tasks or computing processes. For simplicity, the terms “neural networks” and “machine learning models” can be used interchangeably and can be referred to as either “networks” or “models” in short.

In some embodiments, software among or corresponding to software environment 200—and the corresponding systems and methods thereof—utilize deep learning. Deep learning is a subfield of artificial intelligence and machine learning, which, to persons of ordinary skill of the art, corresponds to multilayered implementations of machine learning (commonly known as “deep neural networks”). For simplicity, the terms “machine learning” and “deep learning” can be used interchangeably.

As known to a person of ordinary skill in the art, machine learning is commonly utilized for performing and/or automating one or more tasks such as identification, classification, determination, adaptation, grouping, and generation, among other things. Common types (i.e., classes or techniques) of machine learning include supervised, unsupervised, regression, classification, reinforcement, and clustering, among others.

Among these machine learning types are a number of model implementations, such as linear regression, logistic regression, evolution strategies (ES) or other gradient-based optimization techniques (e.g., stochastic gradient descent, momentum methods, Adam optimizer, etc.), convolutional neural networks (CNN), deconvolutional neural networks (DNN), generative adversarial networks (GAN), recurrent neural networks (RNN), large language models (LLM), and random forest, among others. As known to a person of ordinary skill in the art, one or more machine learning models can be configured and trained for performing one or more tasks at runtime of the model.

As known to a person of ordinary skill in the art, the output of a machine learning model is based at least in part on its configuration and training data. The data that models are trained on (e.g., training data) can include one or more data types. In some embodiments, the training data of a model can be changed, updated, and/or supplemented throughout training and/or inference (i.e., runtime) of the model. In some embodiments, training data corresponds to one or more data types corresponding to software among software environment 200.

A “machine learning module” is a software module and/or hardware module including computer-executable instructions to configure, train, and/or deploy (i.e., execute) one or more machine learning models. In some embodiments, software corresponding to software environment 200 includes one or more machine learning modules.

### System for Generating Canonical and Localized Game Content

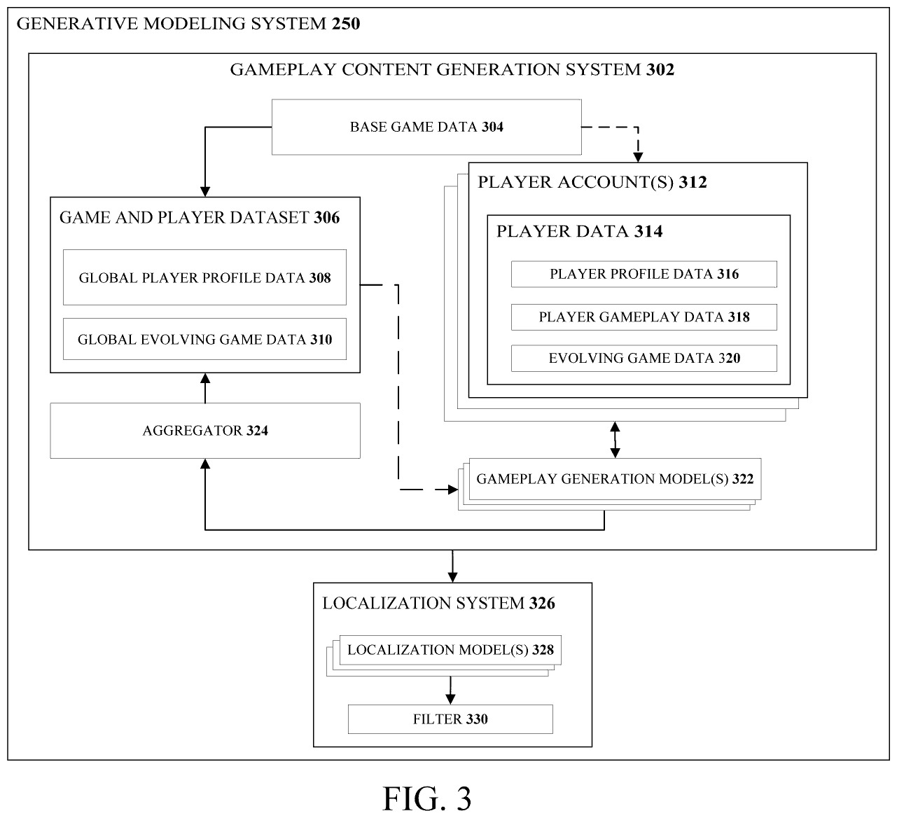

FIG. 3 illustrates an example embodiment of a generative modeling system 250 for generating canonical and localized game content. Software, such as a video game (or “game” in short), can be configured to utilize generative modeling system 250. For example, generative modeling system 250 may be a service provided to a video game or software associated with a video game, such as a companion application. In some embodiments, a user or player of a game may elect or configure a game and/or a corresponding companion application to a game to access generative modeling system 250.

In some embodiments, the generative modeling system 250 includes a gameplay content generation system 302, and a localization system 326. The gameplay content generation system 302 includes base game data 304, a game and player dataset 306, one or more player accounts 312 (generally referred to as “player account 312”), and an aggregator 324.

The base game data 304 may include developer provided information about the game such as historical game references, character backstories, background imagery, interactive objects, non-interactive objects, game lore, and game mechanics. In some embodiments, the game and player dataset 306 includes a global player profile data 308 and a global evolving game data 310. The global player profile data 308 may include anonymized aggregated player profile data. The aggregated player profile data may be organized by demographic or geographic information. The global evolving game data 310 may include the base game data 304 as well as data corresponding to gameplay content generated by a gameplay generation model 322. The global evolving game data 310 may accumulate more data over time as more content is generated by a gameplay generation models 322.

In some embodiments, the player account 312 includes player data 314 and one or more gameplay generation models 322 (generally referred to as “gameplay generation model 322”). In some embodiments, player data 314 includes player profile data 316, player gameplay data 318, and evolving game data 320. The player profile data 316 may include information about a player including username, account identifier, age, gender, religion, language preference, country, or geographic region. The player gameplay data 318 may include in-game gameplay data and out-of-game gameplay data associated with the game.

In-game gameplay data may include time spent playing or interacting with the game. In-game gameplay data may also include gameplay styles, such as a certain path or paths that a player may desire to take, particular objects or weapons a player may use, particular character appearances or outfits a player may use in a, particular difficulty levels a player prefers, how often a player interacts with the game, non-playable-characters a player likes to interact with, quests a player fulfills, or quests a player declines. In-game gameplay data may also include progress within the game such as the level the player is on, how much of the game's storyline has been completed, a percentage corresponding to how much of the virtual environment or game world the player has interacted with or explored, or how many skills have been increased to a maximum level. In-game gameplay data may be collected during a particular game session or over the course of multiple game sessions.

In some embodiments, such as when configured and/or elected by a user or a player, out-of-game gameplay data associated with the game can be included among player gameplay data 318. Out-of-game gameplay data may include time spent interacting with out-of-game content, or one or more types of out-of-game content a player interacts with. Out-of-game content may include videos, such as tutorials or play-throughs of the game. Out-of-game content may also include blog posts about the game or music playlists with music from the game.

Evolving game data 320 may include the player profile data 316, the player gameplay data 318, as well as data corresponding to gameplay content generated by a gameplay generation model 322. The evolving game data 320 may accumulate more data over time as more content is generated by a gameplay generation models 322 and added to the evolving game data 320. In some embodiments, players can select the level of personalization they want to experience. For instance, a player may desire to have content generated solely based on the player dataset 306 or the base game data 304 and not have generated content added to the evolving game data 320. Additionally, in some embodiments, a player may select to play the game based on the base game data 304. For instance, at the start of a new game instance or game session 211, the base game data 304 may be added to the evolving game data 320. A gameplay generation model 322 may then be trained on the evolving game data 320, but not on the evolving game data 320 and the player dataset 306.

A gameplay generation model 322 may be a machine learning model capable of generating gameplay content including game lore, background imagery, character narratives, storytelling, character appearances, player quests, interactive objects, or non-interactive objects. The gameplay generation model 322 may be trained using the player data 314, the base game data 304, and/or the game and player dataset 306. In some embodiments, content generated by a gameplay generation model 322 may be added to the player gameplay data 318, communicated to the aggregator 324, and/or transmitted to the localization system 326. A gameplay generation model 322 may be trained multiple times, as new data is added to the game and player dataset 306 or the player data 314.

In some embodiments, a gameplay generation model 322 can generate gameplay content, such as game lore. Game lore may include a history of the game world. For instance, if the game is a fantasy game, a gameplay generation model 322 may generate a game history including a dragon burning a town, or a witch casting a spell over the land. As another example, if the game is a sports game, a gameplay generation model 322 may generate a game history including tournament history, such as which teams won a championship over the previous 5 years.

In some embodiments, a gameplay generation model 322 can generate character narratives. A character narrative may include a backstory for a character, dialogue for a character, the name of a character, the skills for a character. For example, if the game is a fantasy game, a gameplay generation model 322 may generate a character narrative for a wizard character including the name of the wizard, how the character became a wizard or the types of spells the wizard likes to cast, the skill level for the wizard such as a level of enchantment or magic, or the types of spells the wizard knows. The gameplay generation model 322 may also generate dialogue for the wizard character to interact with a player, such as “have you come to seek out my spells?”

In some embodiments, a gameplay generation model 322 can generate player quests. Player quests may include a story path for a player to follow, such a particular set of places in the game for the player to visit, characters to interact with, or objects to interact with or collect. For instance, if the game is a fantasy game, a gameplay generation model 322 may generate a player quest where the player helps a wizard collect ingredients for a spell.

In some embodiments, a gameplay generation model 322 can generate interactive or non-interactive objects. For example, if the game is a fantasy game, a gameplay generation model 322 may generate objects that look like vials of potions or other ingredients for a wizard's spell and a shelf for the objects to appear on. A player may be able to interact with some of the generated vials, and some may be just for a visual effect to make a shelf look full.

In some embodiments, a gameplay generation model 322 can generate background imagery. Background imagery may be two-dimensional or three-dimensional imagery of the game world or landscape. Background imagery may include indoor or outdoor imagery. Indoor imagery may include the inside of a home or shop. Outdoor imagery may include imagery of a town, a forest, a desert, a beach, or other type of nature or environment. The background imagery of the same town may evolve over time. For instance, when the game is initially launched, a gameplay generation model 322 may generate background imagery of a town in which all the buildings standing and undamaged. A year after launch, the global evolving game data 310 may include game lore that a dragon destroyed the town. Consequently, another gameplay generation model 322 may generate background imagery of the town in which several of the buildings are destroyed or burned.

Further, in some embodiments, a gameplay generation model 322 can generate character characteristics. Character characteristics may include the way a character looks, such as facial features, weight, height, etc. Character characteristics may also include clothing for a character. In some cases, a character may not be human. For instance, if a character is a mermaid, a gameplay generation model 322 may generate a character appearance including the look of a tail, including the color of scales.

The aggregator 324 may receive content generated by a gameplay generation model 322. The aggregator 324 may analyze the received content to determine whether to add the generated content, portions of the generated content, or data associated with the generated content to the game and player dataset 306. For instance, the aggregator 324 may analyze the received content to determine whether the content and any corresponding data is similar to or the same as content generated by another gameplay generation model 322. For instance, one gameplay generation model 322 associated with a first player may generate a quest for the first player including steps A, B, C, and D. Another gameplay generation model 322 associated with a second player may generate a quest for the second player including steps A, B, C, and E. The aggregator 324 may analyze such content and determine to add a quest with steps A, B, and C to the game and player dataset 306 as it is a shared experience between multiple players. As an additional example, aggregator 324 may analyze generated character narratives for similarities, such as a particular character having a certain number or type of siblings, or a character having a relationship with another character.

In some embodiments, the aggregator 324 may be configured to add content once that content has been generated for a certain threshold of players. For instance, if 90% of players have received a quest including steps A, B, and C, the aggregator 324 may determine to add a quest with steps A, B, and C to the global evolving game data 310. In some embodiments, the threshold for aggregation may be based on the type of content generated. For instance, the aggregator may determine to add quest content once the same quest has been generated for 90% of players but may determine to add information or data related to a character narrative once the same character narrative or portions or the character narrative have been generated for 51% of players.

In some embodiments, the aggregator 324 may be configured to determine whether generated content overlaps and consider the overlap when determining whether an aggregation threshold has been met. For example, in a particular embodiment, for 30% of players, a gameplay generation model 322 may generate a character narrative for character A, wherein character A has a relationship with character B. For a different 30% of the players, a gameplay generation model 322 may generate a character narrative for character B, wherein character B has a relationship with character A. In the particular embodiment, the aggregator may be configured to add character narrative information to the game and player dataset 306 once the same character narrative information has been provided to 60% of players. The aggregator 324 may be configured to analyze the character narratives generated for character A and character B to determine that a total of 60% of players have been provided a character narrative where A and B have a relationship. Accordingly, aggregator 324 may add the character narrative of A and B having a relationship to the global evolving game data 310.

In some embodiments, the localization system 326 may include one or more localization model(s) 328 (generically referred to as “localization model 328”) and a filter 330. A localization model 328 may be a machine learning model capable of localizing content using methods including translating text, or generating audio in a particular language, dialect, or accent. The localization model 328 may be capable of translating text such that the translation is appropriate for the language or region, rather than a pure literal translation. For instance, the localization model 328 may be able to translate between American English and British English. The localization model 328 may be able to generate content based on a determination by the localization system 326 that a player is from a particular region of a country. For instance, generated content from a gameplay generation model 322 may comprise the phrase “I bought a soda.” The localization system 326 may determine that a player is from the midwestern United States. Accordingly, the localization system 326 may provide the phrase and the region, midwestern United States, as inputs to the localization model 328. Based on those inputs, the localization model 328 may generate the new phrase “I bought a pop.” In some embodiments, the localization system 326 may train the one or more localization models 328 using sources such as dictionaries, videos, audio recordings, papers, or other content associated with a particular culture, language, or dialect. In some embodiments, the localization system 326 may use player audio or player text input captured by the system to help train the one or more localization models 328.

In some embodiments, the filter may include one or more machine learning models capable of analyzing and/or generating content. For instance, the filter 330 may be configured to analyze content generated by a gameplay content generation system 302 and/or the localization model 328 for any profanities or other violations of local customs or rules. If a profanity or violation is detected, the filter 330 may be configured to generate new content.

### Canonical and Localized Game Content Generation Process

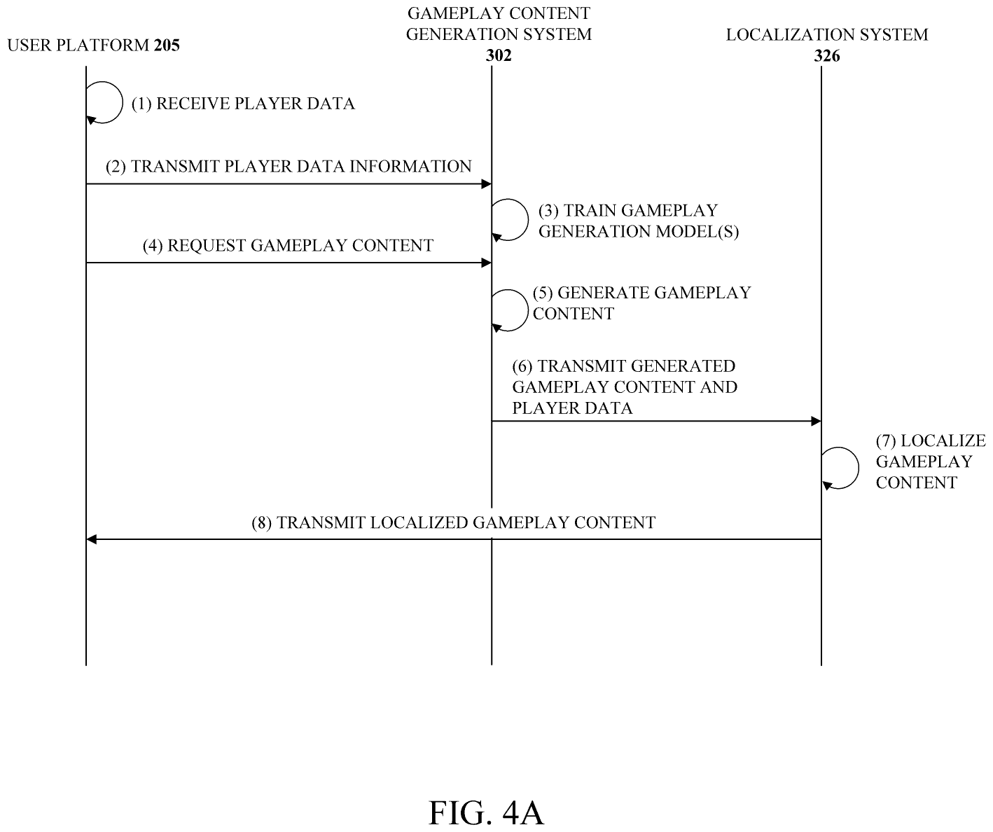

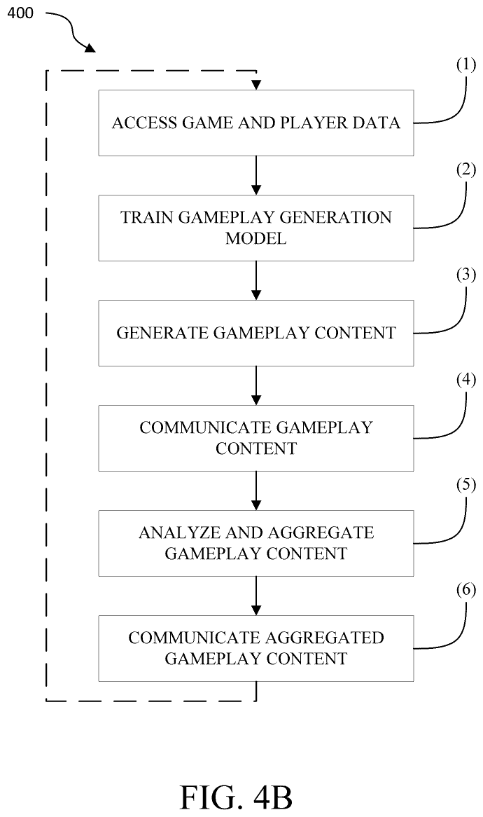

FIG. 4A illustrates a data flow diagram of example communications between various computing devices and systems described herein to generate canonical and localized game content for a video game. Although steps are illustrated in a particular order, steps may be performed multiple times, the order of the steps can be changed, and/or one or more steps can be performed concurrently. Additionally, fewer, more, or different steps can be performed. In the illustrated example, communications are made between a user platform 205, a gameplay content generation system 302, and a localization system 326.

At (1), the user platform 205 receives player data information. The user platform 205 may receive player data information from a user account 201, or the game client 210. For instance, user platform 205 may receive one or more items of player profile data 316 from a user account 201, including a username, player profile identifier, age, gender, religion, language preference, country, or geographic region. The user platform 205 may also receive one or more items of player gameplay data 318 from a game client 210, such as out-of-game gameplay data. The out-of-game gameplay data may include an amount of time spent interacting with out-of-game content, or one or more types of out-of-game content a player interacts with such as videos about the game, blog posts about the game, or music playlists with music from the game. Additionally, in some embodiments, user platform 205 may receive one or more items of player gameplay data 318 from the game client 210, including in-game gameplay data such as the amount of time a player has played or interacted with the game, the gameplay style of a player, or the amount of progress a player has made in the game.

At (2), the user platform 205 transmits the player data 314 to the gameplay content generation system 302. The gameplay content generation system 302 may receive the player data 314, associate the information with a player account 312 based on a username or player profile identifier, and store the player data 314 in the data storage 226.

At (3), the gameplay content generation system 302 trains a gameplay generation model 322 based on the player data 314, the game and player dataset 306, and/or the base game data 304. For example, the gameplay content generation system 302 can train a gameplay generation model 322 to generate gameplay content such as game lore, character narratives, player quests, interactive or non-interactive objects, background imagery, or character characteristics. In some embodiments, the gameplay content generation system 302 can train a gameplay generation model to generate gameplay content based on a subset of the player profile data 316 such as the age of a player, such that an older player may receive more mature content than a younger player. In some embodiments, the gameplay content generation system 302 can train a gameplay generation model to generate gameplay content based on a subset of the player gameplay data 318 including skill level(s). The method of training may differ based on the type of machine-learning model trained.

At (4), the user platform 205 requests a particular type of gameplay content. In some embodiments, the game engine 213 transmits a request for gameplay content to the user platform 205 and the user platform 205 forwards the request to the generative modeling system 250. The generative modeling system 250 then initiates the gameplay content generation system 302.

At (5), the gameplay content generation system 302 generates gameplay content based on the request at (4). In some embodiments, the gameplay content generation system 302 may determine the medium of content to be generated, such as text, imagery, or audio. Based on the determination, the gameplay content generation system 302 may select a particular gameplay generation model 322 that has been trained to generate content of the determined medium. Additionally, the gameplay content generation system 302 may select a particular gameplay generation model 322 based on the type of gameplay content to be generated, such as game lore, character narratives, player quests, interactive or non-interactive objects, background imagery, or character characteristics. The generated gameplay content can be targeted to the player based on a subset of the player gameplay data 318, such as the player skill level or game preferences. For example, a player with a low skill level may receive an easier quest than a player with a high skill level, or such that a battle opponent may be generated with lower health for a player with a low skill level and a higher health for a player with a high skill level.

At (6) the gameplay content generation system 302, transmits the gameplay content generated at (5) to the localization system 326. The gameplay content generation system 302 may also transmit any player data the localization system may use to determine a form of localization to conduct. For instance, the gameplay content generation system 302 may transmit one or more items of player profile data 316, including language preference, country, state, or region. In another embodiment, the gameplay content generation system 302 may transmit one or more items of player gameplay data 318. For example, if the game is a soccer game, the player gameplay data 318 may include a team or country associated with the player in a current game session 211.

At (7), the localization system 326 localizes the generated gameplay content. In some embodiments, the localization system 326 analyzes the generated content and extracts any text or audio that needs to be localized. In some embodiments, the generated gameplay content and player data 314 is input into the localization model 328. The localization model 328 can generate new content based on the inputted generated gameplay content and player profile data 316. For instance, a gameplay generation model 322 may generate text in American English, and the player profile data 316 may indicate that a player lives in France and speaks French as a primary language. The localization model 328 can generate a translation of the text from American English to French. In another example, a gameplay generation model 322 may generate audio corresponding to chanting at a soccer match, and the player gameplay data 318 may indicate that the player is playing as a player from a Mexican team. Accordingly, the localization model 328 may generate new audio corresponding to chants traditionally heard at a Mexican soccer game. In some embodiments, the localization system 326 may generate new content to correspond with cultural norms of a detected country or region. For example, a gameplay generation model 322 may generate a character who is a bride and may generate content in which the bride is dressed in a white dress. The localization system 326 may determine from the player data 314 that the player is located in a country where a different color or style of dress is traditional for brides, such as a vibrantly colored dress.

In some embodiments, content generated by the localization model 328 can be input into the filter 330. In some embodiments, the filter 330 may be configured to analyze the generated localized content for any profanities or other violations of local customs or rules. For instance, a gameplay generation model 322 may generate a character name in American English, that when translated into another language becomes a profanity. The filter 330 may be able to detect the new profanity and generate new non-profane content. The filter 330 may be configured to analyze imagery for symbols that may be banned in certain countries. In some embodiments, content generated by a gameplay generation model 322 may be input directly into the filter rather than into the localization model 328. In some embodiments, the localized gameplay content may include animation generated for character to speak the localized content.

At (8), the localized gameplay content is transmitted to the user platform 205. In some embodiments, the localization system communicates with the user platform 205 directly to transmit the content. In some embodiments, the user platform 205 further transmits the generated content to a user account 201.

In some embodiments, user platform 205 of FIG. 4A corresponds to a video game console executing a video game for gameplay. As such, the gameplay content generation system 302 and localization system 326 can generate and transmit localized gameplay content to the user platform 205 synchronously during gameplay of a video game or asynchronously, so that the localized gameplay content can be used by the video game at a time other than when received by the user platform 205.

In some embodiments, user platform 205 of FIG. 4A corresponds to a computing device executing software corresponding to a video game, such as a companion app. As such, the gameplay content generation system 302 and localization system 326 can generate and transmit localized gameplay content to the user platform 205 for users to enjoy outside of gameplay, such as within the companion app.

In some embodiments, the gameplay content generation system 302 and localization system 326 can transmit localized gameplay content to two or more user platforms 205, such that a single user can receive the localized gameplay content within a video game and/or a companion application.

FIG. 4B illustrates a flowchart of an example process for generating gameplay content. The process 400, in whole or in part, can be implemented by a generative modeling system 250, a gameplay content generation system 302, or other computing system. Although any number of systems, in whole or in part, can implement the process 400, to simplify discussion, the process 400 will be describe with respect to the gameplay content generation system 302.

At (1), the gameplay content generation system 302 accesses game and player data associated with a player account 312 and/or the game and player dataset 306. At (2), the gameplay content generation system 302 trains a gameplay generation model 322 based on the data accessed at (1), as described in FIG. 4A. At (3), the gameplay generation model 322 generates gameplay content, as described in FIG. 4A.

At (4), the generated gameplay content is communicated to components of the gameplay content generation system 302. In some embodiments, the generated gameplay content is added to the evolving game data 320 for an associated player account 312. In some embodiments, the generated gameplay content is transmitted to the aggregator 324. In some embodiments, the aggregator 324 may store the generated content in the data storage 226 for later comparison against later generated content. In some embodiments, a player may desire not to have a personalized game experience, consequently gameplay content generated at (3) may be transmitted to the aggregator 324 but not to the evolving game data 320. Additionally, in some embodiments, a player may opt out of having personalized content aggregated and added to the global evolving game data 310 consequently, gameplay content generated at (3) may be added to the evolving game data 320 but not transmitted to the aggregator 324.

At (5), the aggregator 324 may analyze and aggregate gameplay content to determine whether to add the generated content, portions of the generated content, or data associated with the generated content to the game and player dataset 306, as described with respect to FIG. 3. Based on the analysis, the aggregator 324 may identify data to add to the game and player dataset 306, i.e., data to be aggregated. Data may be added to the global player profile data 308 or the global evolving game data 310. In some embodiments, the aggregator may determine to only add a portion of generated content it receives to the global evolving game data 310, such that content generated at (3) may be transmitted to both the evolving game data 320 and the aggregator 324, but the content added to the evolving game data 320 may differ from the content added to the global evolving game data 310. At (6), the aggregator 324 adds the data to be aggregated to the game and player dataset 306.

This process may repeat in a loop. For instance, after (6), the gameplay content generation system 302 may access the updated game and player dataset 306 and/or an updated player account 312 and retrain the same gameplay generation model 322 as was trained at (2) or may train a new gameplay generation model 322. The gameplay generation model 322 trained on the updated data may now generate different content based on the updated data, which is communicated to the aggregator 324, and/or a player account 312. The aggregator 324 may analyze the new content and determine to add some or all the content to the game and player dataset 306.

### Example Embodiments of Canonical and Localized Gameplay Content Generation

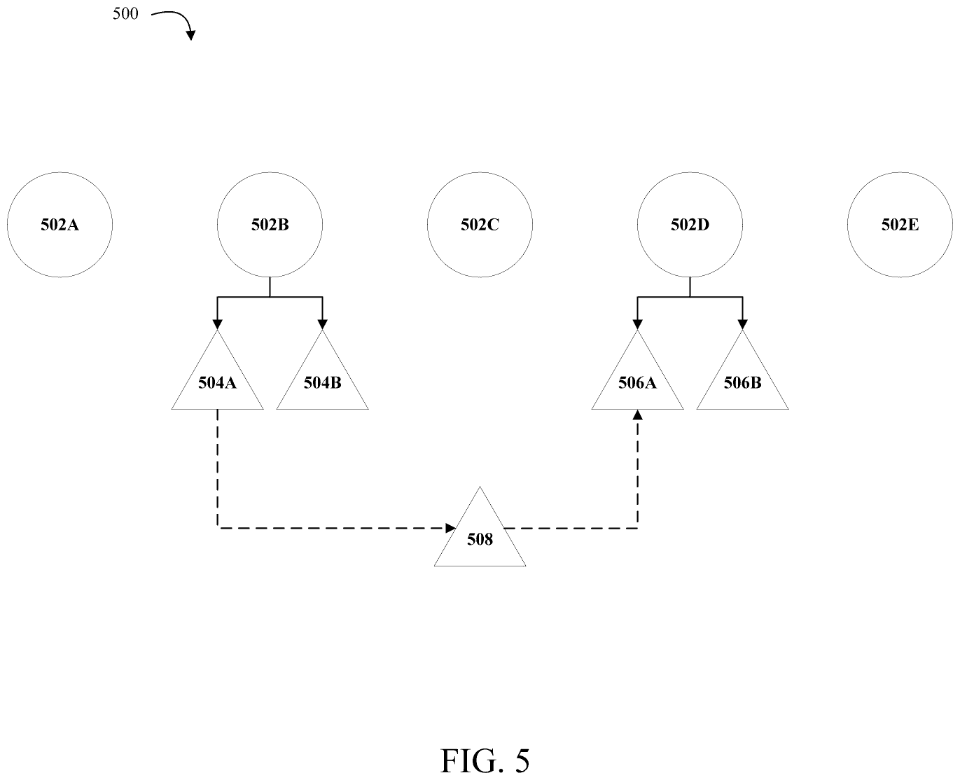

FIG. 5 depicts a schematic diagram 500 of a depiction of base game components 502A-502E (generally referred to as “base game component 502), a first tree of generated gameplay content, comprising originating branches 504A and 504B (generally referred to as “originating branch 504”), a second tree of generated gameplay content comprising influenced branches 506A and 506B (generally referred to as “influence branch 506”), and a generated game component 508, according to an embodiment. In some embodiments, the base game components 502A-502E may represent components in a storyline. For example, if the game is a fantasy game, base game component 502A may represent an initial part of a storyline wherein a player visits a town and explores, base game component 502B may represent a second part of a storyline wherein the player visits a shopkeeper and is sent on a quests, base game component 502C may represent a third part of the storyline wherein the player visits a new part of the world, base game component 502D may represent a fourth part of the storyline wherein the player meets the shopkeeper again, and base game component 502E may represent an ending of the storyline wherein the player decides to live in the town visited at the base game component 502A.

The originating branches 504A and 504B can represent gameplay content generated by separate gameplay generation models 322 at the same point in the storyline. For example, if a base game component 502B includes a player receiving a personalized quest, originating branch 504A may correspond to a quest generated by a gameplay generation model 322 for a first player who has not played the game before, whereas originating branch 504B may correspond to a quest generated by a gameplay generation model 322 for a second player who has played and completed the game multiple times and thus may be more familiar with aspects of the game such as the game mechanics, the game lore, or the location of objects within the game world. In such case, originating branch 504A may be associated with a different quest than originating branch 504B.

The influenced branches 506A and 506B can represent gameplay content generated by separate gameplay generation models 322 at the same point in the storyline, wherein the separate gameplay generation models 322 have been trained on the data and/or content generated for the originating branches 504A and 504B. For example, a first player may progress to the base game component 502B, a quest for a shopkeeper may be generated by a gameplay generation model 322, the quest corresponding to originating branch 504A, and the generated quest content and/or data may be added to the evolving game data 320 corresponding to the player account 312 associated with the first player. The first player may then progress to the base game component 502D, dialogue for the shopkeeper may be generated by a gameplay generation model 322, which has been trained on the evolving game data 320 corresponding to the player account 312 associated with the first player, which contains the content and/or data associated with the originating branch 504A, the generated dialogue corresponding to the influenced branch 506A. Because the generated dialogue may be generated by a gameplay generation model 322 trained based at least in part on the originating branch 504A, the dialogue may incorporate references to the originating branch 504A. Additionally, as described above, a second player may receive a different quest, corresponding to originating branch 504B, and thus influenced branch 506B may differ from influenced branch 506A.

The generated game component 508 may represent a component in a storyline generated based on an originating branch 504 or an influence branch 506. The generated game component 508 may be analogous to a base game component 502, but rather than being a hard-coded storyline event, the generated game component 508 may be generated by a gameplay generation model 322. For example, as illustrated in the example embodiment, the generated game component 508 is generated based on the originating branch 504A. For instance, base game components 502A-502E may include a player visiting three towns, and originating branch 504A may correspond to a quest generated by a gameplay generation model 322 where the player must travel to find items for a shopkeeper. Generated game component 508 may correspond to a player visiting a fourth town in order to find the items needed for the quest. Additionally, while visiting the fourth town, the player may interact with a character such as a butcher. Consequently, influenced branch 506A may correspond to gameplay content generated based at least in part on originating branch 504A and generated game component 508. For instance, influenced branch 506A may correspond to dialogue for the shopkeeper in which the shopkeeper references the quest, the fourth town, and the butcher.

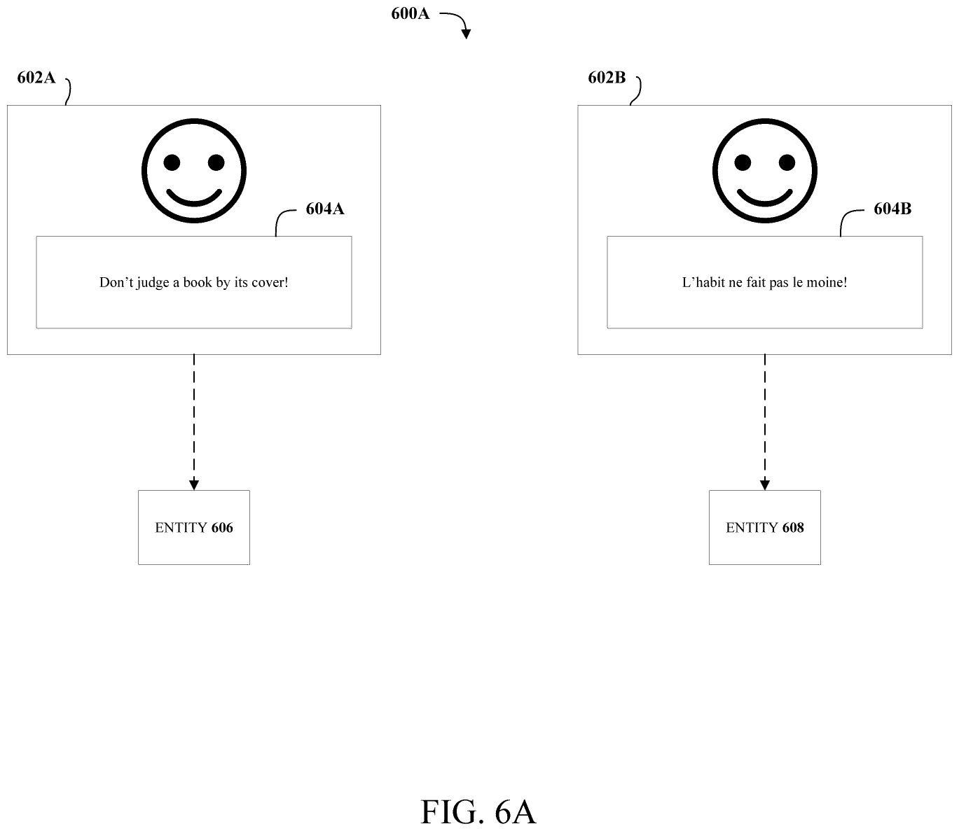

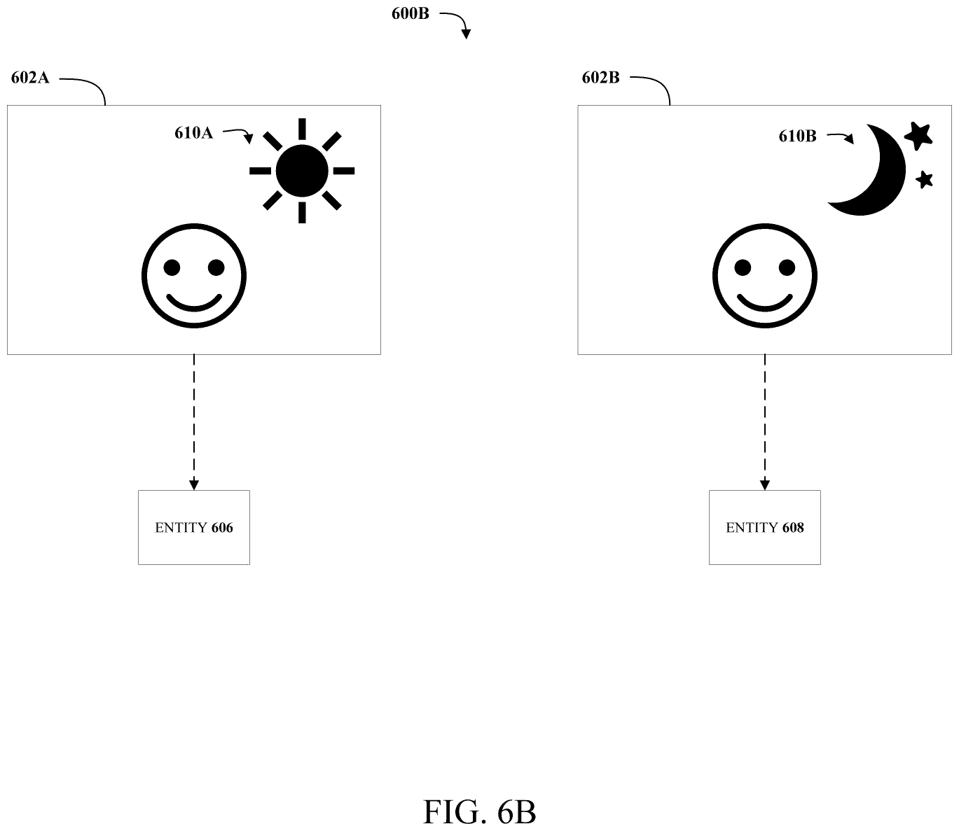

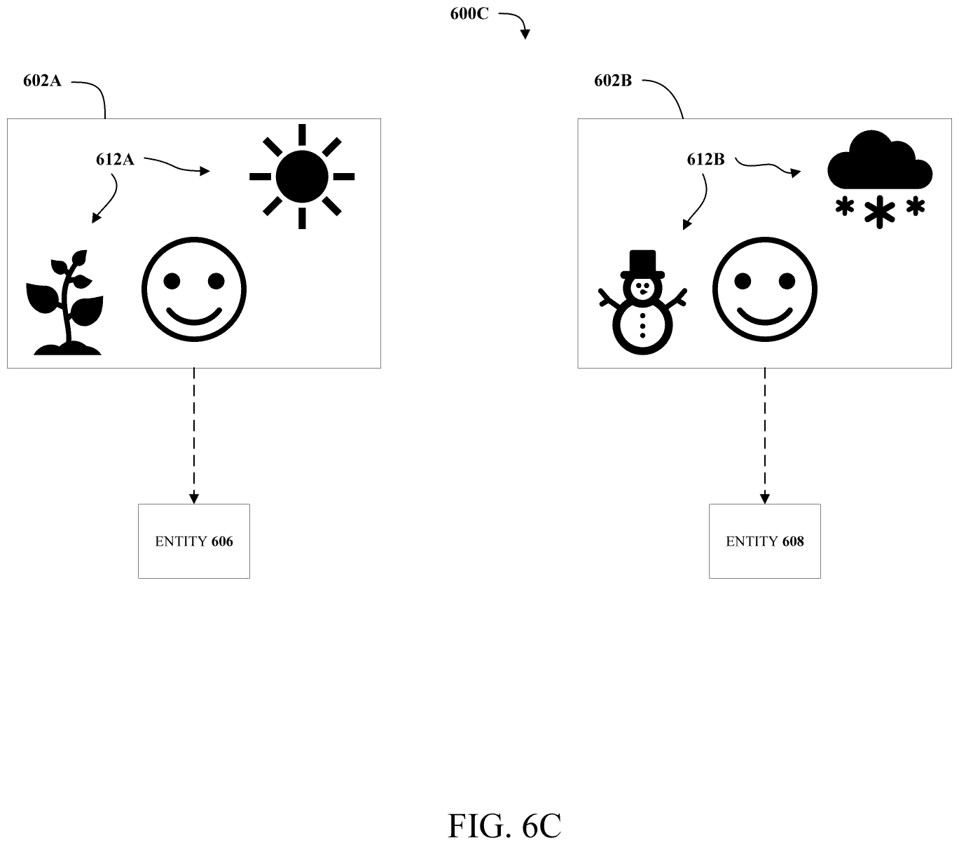

FIGS. 6A-6C illustrate schematic diagrams 600A, 600B, and 600C of a first depiction of a generated gameplay content 604A, 610A, 612A expressed in a virtual space 602A and a second depiction of a generated gameplay content 604B, 610B, 612B expressed in a virtual space 602B as perceived by different entities 606 and 608, according to several embodiments. Different depictions of the generated gameplay content may be provided to and/or in relation with different entities. For example, entity 606 may be provided with a first depiction of the generated gameplay content 604A and entity 608 may be provided with a second depiction of the generated gameplay content 604B, thereby causing the different entities to have different perceptions of the generated gameplay content. Both entities may be provided with the same depiction of the first generate gameplay content, thereby causing the different entities to have the same perception of the generated gameplay content.

The different depictions may be provided to the different entities for various reasons. For example, FIG. 6A illustrates an embodiment where entity 606 has a different language preference than entity 608. In the illustrated embodiment, entity 606 has a geographic location as the United States and a language preference of English, whereas entity 608 has a geographic location as France and a language preference of French. A gameplay generation model 322 has generated gameplay content comprising “Don't judge a book by it's cover!” which was transmitted to the localization system 326 and input into a localization model 328 along with the geographic location and language preference of entity 608. Accordingly, the localization model 328 output translated generated gameplay content for entity 608. Consequently, entity 606 perceives the generated gameplay content “Don't judge a book by it's cover!” (first depiction 604A) whereas entity 608 perceives the generated gameplay content “L′habit ne fait pas le moine!” (second depiction 604B). The second depiction of the generated gameplay content 604B further illustrates how the localization system 326 may be configured to translate generated gameplay content from one language to another while using awareness of cultural norms. For example, the literal translation of “don't judge a book by its cover,” in French is “ne juge pas un livre à sa couverture.” But, in the French language a different idiom is used to convey the same meaning, “l′habit ne fait pas le moine,” which literally translated in English means “the clothes do not make the man.”

As another example of different depictions of generated game content being provided to different entities, FIG. 6B illustrates an embodiment where entity 606 is located in a different time zone than entity 608. For example, entity 606 may be located in a region that follows Eastern Daylight Time (EDT), such as the eastern United States, whereas entity 608 may be located in a region that follows Greenwich Mean Time (GMT), such as England, with both entities playing the game simultaneously at 3:00 PM EDT, 7:00 PM GMT. The localization system 326 may be configured to determine that, based on the times, the sun has set for entity 608, but the sun is still up for entity 606. A localization model 328 may take as input background imagery generated by a gameplay generation model 322 in which it is sunny or daytime along with the time zone and current time for entity 608. The localization model 328 may output a version of the background imagery generated by gameplay generation model 322 in which it is dark or nighttime. Accordingly, as illustrated, entity 606 may perceive background imagery in which it is daytime (first depiction 610A), whereas entity 608 may perceive background imagery in which it is nighttime (second depiction 610B).

As a further example different depictions of generated game content being provided to different entities, FIG. 6C illustrates an embodiment where entity 606 is located in a different geographical region than entity 608. For example, entity 606 may be located in Miami, Florida, United States, whereas entity 608 may be located in Juneau, Alaska, United States, with both entities playing the game simultaneously on March 1st. The localization system 326 may be configured to determine that, based on the entities' locations, the temperature is warmer for entity 606 (77° F.) than for entity 608 (24° F.). A localization model 328 may take as input background imagery generated by a gameplay generation model 322 illustrating a warm climate including sunshine and greenery along with the geographic location of entity 608 and the temperature of the geographic location of entity 608. The localization model 328 may output a version of the background imagery illustrating a cold climate including snow and snowmen. Accordingly, as illustrated, entity 606 may perceive background imagery depicting a warm climate (first depiction 612A), whereas entity 608 may perceive background imagery depicting a cold climate (second depiction 612B).

### Computing Device

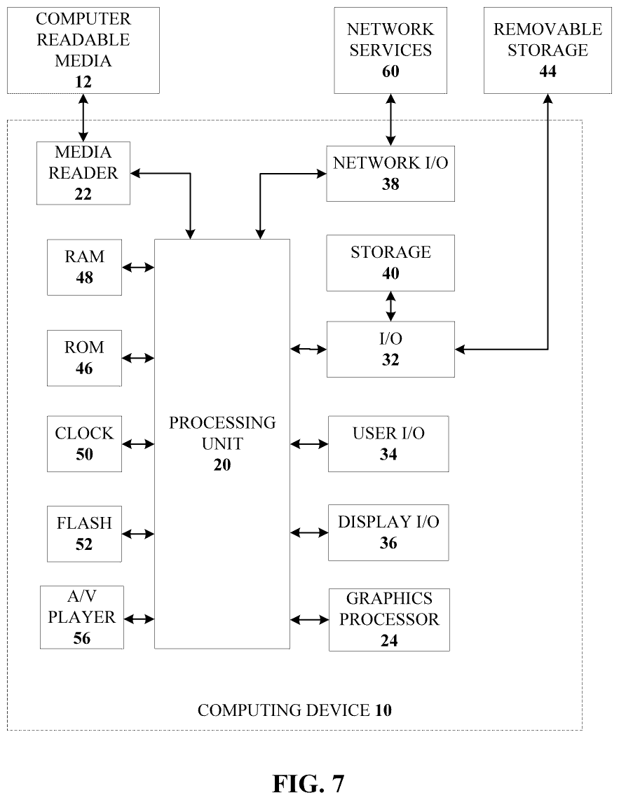

FIG. 7 illustrates an example embodiment of the resources within a computing device 10. In some embodiments, some or all of the aforementioned hardware devices—such as computing devices 110 and server devices 130 of FIG. 1—are similar to computing device 10, as known to those of skill in the art.

Other variations of the computing device 10 may be substituted for the examples explicitly presented herein, such as removing or adding components to the computing device 10. The computing device 10 may include a video game console, a smart phone, a tablet, a personal computer, a laptop, a smart television, a server, and the like.

As shown, the computing device 10 includes a processing unit 20 that interacts with other components of the computing device 10 and external components. A media reader 22 is included that communicates with computer readable media 12. The media reader 22 may be an optical disc reader capable of reading optical discs, such as DVDs or BDs, or any other type of reader that can receive and read data from computer readable media 12. One or more of the computing devices may be used to implement one or more of the systems disclosed herein.

Computing device 10 may include a graphics processor 24. In some embodiments, the graphics processor 24 is integrated into the processing unit 20, such that the graphics processor 24 may share Random Access Memory (RAM) with the processing unit 20. Alternatively, or in addition, the computing device 10 may include a discrete graphics processor 24 that is separate from the processing unit 20. In some such cases, the graphics processor 24 may have separate RAM from the processing unit 20. Computing device 10 might be a video game console device, a general-purpose laptop or desktop computer, a smart phone, a tablet, a server, or other suitable system.

Computing device 10 also includes various components for enabling input/output, such as an I/O 32, a user I/O 34, a display I/O 36, and a network I/O 38. I/O 32 interacts with storage element 40 and, through a device 42, removable storage media 44 in order to provide storage for computing device 10. Processing unit 20 can communicate through I/O 32 to store data. In addition to storage 40 and removable storage media 44, computing device 10 is also shown including ROM (Read-Only Memory) 46 and RAM 48. RAM 48 may be used for data that is accessed frequently during execution of software.

User I/O 34 is used to send and receive commands between processing unit 20 and user devices, such as keyboards or game controllers. In some embodiments, the user I/O can include a touchscreen. The touchscreen can be a capacitive touchscreen, a resistive touchscreen, or other type of touchscreen technology that is configured to receive user input through tactile inputs from the user. Display I/O 36 provides input/output functions that are used to display images. Network I/O 38 is used for input/output functions for a network. Network I/O 38 may be used during execution, such as when a client is connecting to a server over a network.

Display output signals produced by display I/O 36 comprising signals for displaying visual content produced by computing device 10 on a display device, such as graphics, GUIs, video, and/or other visual content. Computing device 10 may comprise one or more integrated displays configured to receive display output signals produced by display I/O 36. According to some embodiments, display output signals produced by display I/O 36 may also be output to one or more display devices external to computing device 10, such as display 16.

The computing device 10 can also include other features, such as a clock 50, flash memory 52, and other components. An audio/video player 56 might also be used to play a video sequence, such as a movie. It should be understood that other components may be provided in computing device 10 and that a person skilled in the art will appreciate other variations of computing device 10.

Program code can be stored in ROM 46, RAM 48, or storage 40 (which might comprise hard disk, other magnetic storage, optical storage, other non-volatile storage or a combination or variation of these). Part of the program code can be stored in ROM that is programmable (ROM, PROM, EPROM, EEPROM, and so forth), part of the program code can be stored in storage 40, and/or on removable media such as media 12 (which can be a CD-ROM, cartridge, memory chip or the like, or obtained over a network or other electronic channel as needed). In general, program code can be found embodied in a tangible non-transitory signal-bearing medium.

Random access memory (RAM) 48 (and other storage) is usable to store variables and other processor data as needed. RAM is used and holds data that is generated during the execution of an application and portions thereof might also be reserved for frame buffers, application state information, and/or other data needed or usable for interpreting user input and generating display outputs. Generally, RAM 48 is volatile storage and data stored within RAM 48 may be lost when the computing device 10 is turned off or loses power.

As computing device 10 reads media 12 and provides an application, information may be read from media 12 and stored in a memory device, such as RAM 48. Additionally, data from storage 40, ROM 46, servers accessed via a network (not shown), or removable storage media 46 may be read and loaded into RAM 48. Although data is described as being found in RAM 48, it will be understood that data does not have to be stored in RAM 48 and may be stored in other memory accessible to processing unit 20 or distributed among several media, such as media 12 and storage 40.

Some portions of the detailed descriptions above are presented in terms of symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

The disclosed subject matter also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The disclosed subject matter may be provided as a computer program product, or software, that may include a machine-readable medium having stored thereon instructions, which may be used to program a computer system (or other electronic devices) to perform a process according to the disclosed subject matter. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.).

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

Certain example embodiments are described above to provide an overall understanding of the principles of the structure, function, manufacture and use of the devices, systems, and methods described herein. One or more examples of these embodiments are illustrated in the accompanying drawings. Those skilled in the art will understand that the descriptions herein and the accompanying drawings are intended to be illustrative, and not restrictive. Many other implementations will be apparent to those of skill in the art based upon the above description. Such modifications and variations are intended to be included within the scope of the present disclosure. The scope of the present disclosure should, therefore, be considered with reference to the claims, along with the full scope of equivalents to which such claims are entitled. The features illustrated or described in connection with one exemplary embodiment may be combined with the features of other embodiments. In some instances, well-known structures and devices are shown in block diagram form, rather than in detail, in order to avoid obscuring the disclosed subject matter.

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, for example, a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A computing system comprising:
one or more processors; and
one or more memory devices, wherein the one or more memory devices are communicatively coupled to the one or more processors, the one or more memory devices storing computer-executable instructions including at least a gameplay content generation system comprising base game data, global game data, a plurality of player accounts, and one or more gameplay generation models, wherein the base game data comprises one or more base game components, and wherein each of the plurality of player accounts is associated with a plurality of player data, wherein execution of the computer-executable instructions by the one or more processors causes, during runtime, at least one of the one or more processors to generate gameplay content within a virtual interactive environment of a video game by:
receiving first player data, wherein the first player data is associated with a first player account of the plurality of player accounts;
adding the first player data to a first plurality of player data associated with the first player account;
training a first gameplay generation model of the one or more gameplay generation models using at least one of the global game data and the first plurality of player data;
receiving a first request to generate gameplay content corresponding to a first base game component;
generating first gameplay content, wherein the first gameplay content corresponds to the first base game component;
adding the first gameplay content to the first plurality of player data and the global game data; and
outputting the first gameplay content within the virtual interactive environment of the video game.

2. The computing system of claim 1, wherein player data comprises at least one of:
an amount of time a player has spent playing the video game, an amount of progress a player has made in completing a storyline of the video game, objects a player has previously interacted with in the video game, characters a player has previously interacted with in the video game, types of interactions the player has had within the video game, a percentage corresponding to how much of the virtual interactive environment the player has interacted with.

3. The computing system of claim 1, wherein execution of the computer-executable instructions further causes at least one of the one or more processors to generate gameplay content by:
retraining, by the gameplay content generation system, the first gameplay generation model using at least one of the global game data and first plurality of player data;
receiving, at the gameplay content generation system, a second request to generate gameplay content corresponding to the first gameplay content; and
generating, by the first gameplay generation model, second gameplay content, wherein the second gameplay content corresponds to the first gameplay content.

4. The computing system of claim 1, wherein execution of the computer-executable instructions further causes at least one of the one or more processors to generate gameplay content by:
transmitting, by the gameplay content generation system, the first gameplay content to an aggregator; and
aggregating, by the aggregator, the first gameplay content, wherein aggregating the first gameplay content comprises:
comparing the first gameplay content to third gameplay content, wherein the third gameplay content is gameplay content generated by a second gameplay generation model of the one or more gameplay generation models, and wherein the second gameplay generation model is trained, at least in part, on a second plurality of player data associated with a second player account of the plurality of player accounts,
determining, based on comparing the first gameplay content to third gameplay content, to add the first gameplay content to the global game data, and
adding the first gameplay content to the global game data.

5. The computing system of claim 1, wherein at least one of the one or more gameplay generation models is a machine-learning model.

6. The computing system of claim 1, wherein execution of the computer-executable instructions further causes at least one of the one or more processors to generate gameplay content by:
transmitting the first gameplay content to a user platform, wherein the user platform is configured to communicate with one or more user computing devices.

7. The computing system of claim 1, wherein execution of the computer-executable instructions further causes at least one of the one or more processors to generate gameplay content by:
transmitting the first gameplay content to a localization system, wherein the localization system comprises one or more localization models;
transmitting second player data associated with the first plurality of player data, the second player data comprising a preferred language associated with the first player account; and
localizing, by the localization system, the first gameplay content, wherein localizing the first gameplay content comprises:
inputting into at least one of the one or more localization models the first gameplay content and the second player data, wherein the first gameplay content is associated with a language different from the preferred language, and
receiving from the at least one of the one or more localization models, third gameplay content wherein the third gameplay content is associated with the preferred language.

8. The computing system of claim 7,
wherein the localization system further comprises a filter, and
wherein execution of the computer-executable instructions further causes at least one of the one or more processors to generate gameplay content by:
filtering, by the filter, the third gameplay content, wherein filtering the third gameplay content comprises:
determining that the third gameplay content contains at least one of profanities or banned content,
inputting the third gameplay content into a machine-learning model, and
receiving fourth gameplay content, wherein the fourth gameplay content does not contain profanities or banned content.

9. The computing system of claim 1, wherein execution of the computer-executable instructions further causes at least one of the one or more processors to generate gameplay content by:
receiving, at the gameplay content generation system, second player data, wherein the second player data is associated with a second player account of the plurality of player accounts;
adding the second player data to a second plurality of player data associated with the second player account;
training, by the gameplay content generation system, a second gameplay generation model of the one or more gameplay generation models using at least one of the global game data and the second plurality of player data;
receiving, at the gameplay content generation system, a third request to generate gameplay content corresponding to the first base game component; and
generating, by the first gameplay generation model, third gameplay content, wherein the third gameplay content corresponds to the first base game component, and wherein the third gameplay content is different from the first gameplay content.

10. A computer-implemented method to generate gameplay content within a virtual interactive environment of a video game comprising:
receiving, at a gameplay content generation system, first player data,
wherein the gameplay content generation system comprises:
base game data, global game data, a plurality of player accounts, and one or more gameplay generation models,
wherein the base game data comprises one or more base game components, and
wherein each of the plurality of player accounts is associated with a plurality of player data, and
wherein the first player data is associated with a first player account of the plurality of player accounts;
adding the first player data to a first plurality of player data associated with the first player account;
training a first gameplay generation model of the one or more gameplay generation models using at least one of the global game data and the first plurality of player data;
receiving a first request to generate gameplay content corresponding to a first base game component;
generating first gameplay content, wherein the first gameplay content corresponds to the first base game component;
adding the first gameplay content to the first plurality of player data and the global game data; and
outputting the first gameplay content within the virtual interactive environment of the video game.

11. The computer-implemented method of claim 10, wherein player data comprises at least one of:
an amount of time a player has spent playing the video game, an amount of progress a player has made in completing a storyline of the video game, objects a player has previously interacted with in the video game, characters a player has previously interacted with in the video game, types of interactions the player has had within the video game, a percentage corresponding to how much of the virtual interactive environment the player has interacted with.

12. The computer-implemented method of claim 10, further comprising:
retraining, by the gameplay content generation system, the first gameplay generation model using at least one of the global game data and first plurality of player data;
receiving, at the gameplay content generation system, a second request to generate gameplay content corresponding to the first gameplay content; and
generating, by the first gameplay generation model, second gameplay content, wherein the second gameplay content corresponds to the first gameplay content.

13. The computer-implemented method of claim 10, further comprising:
transmitting, by the gameplay content generation system, the first gameplay content to an aggregator; and
aggregating, by the aggregator, the first gameplay content, wherein aggregating the first gameplay content comprises:
comparing the first gameplay content to third gameplay content, wherein the third gameplay content is gameplay content generated by a second gameplay generation model of the one or more gameplay generation models, and wherein the second gameplay generation model is trained, at least in part, on a second plurality of player data associated with a second player account of the plurality of player accounts,
determining, based on comparing the first gameplay content to third gameplay content, to add the first gameplay content to the global game data, and
adding the first gameplay content to the global game data.

14. The computer-implemented method of claim 10, wherein at least one of the one or more gameplay generation models is a machine-learning model.

15. The computer-implemented method of claim 10, further comprising:
transmitting the first gameplay content to a user platform, wherein the user platform is configured to communicate with one or more user computing devices.

16. The computer-implemented method of claim 10, further comprising:
transmitting the first gameplay content to a localization system, wherein the localization system comprises one or more localization models;
transmitting second player data associated with the first plurality of player data, the second player data comprising a preferred language associated with the first player account; and
localizing, by the localization system, the first gameplay content, wherein localizing the first gameplay content comprises:
inputting into at least one of the one or more localization models the first gameplay content and the second player data, wherein the first gameplay content is associated with a language different from the preferred language, and
receiving from the at least one of the one or more localization models, third gameplay content wherein the third gameplay content is associated with the preferred language.

17. The computer-implemented method of claim 16,
wherein the localization system further comprises a filter, and
wherein the computer-implemented method further comprises:
filtering, by the filter, the third gameplay content, wherein filtering the third gameplay content comprises:
determining that the third gameplay content contains at least one of profanities or banned content,
inputting the third gameplay content into a machine-learning model, and
receiving fourth gameplay content, wherein the fourth gameplay content does not contain profanities or banned content.

18. The computer-implemented method of claim 10, further comprising:
receiving, at the gameplay content generation system, second player data, wherein the second player data is associated with a second player account of the plurality of player accounts;
adding the second player data to a second plurality of player data associated with the second player account;
training, by the gameplay content generation system, a second gameplay generation model of the one or more gameplay generation models using at least one of the global game data and the second plurality of player data;
receiving, at the gameplay content generation system, a third request to generate gameplay content corresponding to the first base game component; and
generating, by the first gameplay generation model, third gameplay content, wherein the third gameplay content corresponds to the first base game component, and wherein the third gameplay content is different from the first gameplay content.

19. A non-transitory computer readable medium comprising computer-executable instructions that, when executed by one or more processors, cause the one or more processors to generate gameplay content within a virtual interactive environment of a video game by:
receiving, at a gameplay content generation system, first player data,
wherein the gameplay content generation system comprises:
base game data, global game data, a plurality of player accounts, and one or more gameplay generation models,
wherein the base game data comprises one or more base game components, and
wherein each of the plurality of player accounts is associated with a plurality of player data, and
wherein the first player data is associated with a first player account of the plurality of player accounts;
adding the first player data to a first plurality of player data associated with the first player account;
training a first gameplay generation model of the one or more gameplay generation models using at least one of the global game data and the first plurality of player data;
receiving a first request to generate gameplay content corresponding to a first base game component;
generating first gameplay content, wherein the first gameplay content corresponds to the first base game component;
adding the first gameplay content to the first plurality of player data and the global game data; and
outputting the first gameplay content within the virtual interactive environment of the video game.

20. The non-transitory computer readable medium of claim 19, wherein execution of the computer-executable instructions further causes the one or more processors to generate gameplay content by:
transmitting, by the gameplay content generation system, the first gameplay content to an aggregator, and
aggregating, by the aggregator, the first gameplay content, wherein aggregating the first gameplay content comprises:
comparing the first gameplay content to third gameplay content, wherein the third gameplay content is gameplay content generated by a second gameplay generation model of the one or more gameplay generation models, and wherein the second gameplay generation model is trained, at least in part, on a second plurality of player data associated with a second player account of the plurality of player accounts,
determining, based on comparing the first gameplay content to third gameplay content, to add the first gameplay content to the global game data, and
adding the first gameplay content to the global game data.
